(19) United States
(12) Patent Application Publication
(10) Pub. No.: US 2018/0173199 A1
(43) Pub. Date: Jun. 21, 2018

(54) APPARATUS FOR PROTECTING COPYRIGHT OF 3D OBJECT MODEL AND METHOD THEREFOR

(71) Applicant: MARKANY INC., Seoul (KR)

(72) Inventors: Hyoung-jun KIM, Seoul (KR); Hong-joon HA, Seoul (KR); Mun-hee WON, Seoul (KR); Kyoung-hee HWANG, Uijeongbu-si (KR); Jae-hong KIM, Gimpo-si (KR); Jong-uk CHOI, Seoul (KR)

(73) Assignee: MARKANY INC., Seoul (KR)

(21) Appl. No.: 15/822,115

(22) Filed: Nov. 24, 2017

(30) Foreign Application Priority Data
Dec. 15, 2016 (KR) 10-2016-0171755

(51) Int. Cl. G05B 19/408; G05B 19/4099; G06Q 50/18; H04L 9/14

(52) U.S. Cl. CPC G05B 19/4083; G05B 19/4099; H04L 2209/16; H04L 9/14; G05B 2219/49007; G06Q 50/184

(57) ABSTRACT

Disclosed is an apparatus for protecting a copyright of a 3D object model and method therefor, the apparatus including: a first module generating an original 3D object model by combining voxels in a 3D space of X, Y, and Z axes; a second module calculating voxel lengths of the axes and based on a voxel length of a longest axis among the lengths, the second module extending lengths of the remaining axes, thereby obtaining a 3D space area; a third module generating an obfuscation unique key; a fourth module generating at least one rotation axis position, rotation voxel range, and rotation frequency based on the key; and a fifth module axially rotating at least one voxel structure included in each rotation voxel range at a rotation angle by each rotation frequency to distort a shape of the model, thereby performing obfuscation. Accordingly, the copyright can be effectively protected.

### CROSS REFERENCE TO RELATED APPLICATION

The present application claims priority to Korean Patent Application No. 10-2016-0171755, filed Dec. 15, 2016, the entire contents of which is incorporated herein by reference in its entirety.

### BACKGROUND OF THE INVENTION

### Field of the Invention

The present invention relates generally to an apparatus for protecting a copyright of a 3D object model and method therefor, and computer-readable recording medium having a program recorded thereon, the program enabling the method.

Description of the Related Art

Generally, 3D printing is a manufacturing technology that produces a 3D object model by spraying materials in successive layers. Recently, a demand for 3D printing has been rapidly increased due to development of related technologies.

Also, the 3D printer is a device for manufacturing an actual 3D output by receiving a 3D object model implemented on a computer.

Also, a 3D printer of a material spraying method that can print a 3D object model with various materials and colors has been manufactured. In order to print more useful and realistic 3D object models, a technology for converting an input model into unit elements (voxel, etc.) having fixed volumes and assigning print properties such as color, material, etc. to each unit element has been developed.

In consequence of rapid development in a computer, the internet, a storage medium, etc., various documents, content, etc. are produced in a computer-readable digital data format and distributed. However, due to characteristics of the digital content, namely, the 3D object model, it is easy to produce and distribute copies of the original or modifications thereof.

Thus, a copyrighter of the 3D object model requiring substantial money, time, creativity, and labor desires complete on-line and off-line protection of the copyright. However, easy coping and distribution of the 3D object model as described above are major obstacles in invigorating the digital content market.

The foregoing is intended merely to aid in the understanding of the background of the present invention, and is not intended to mean that the present invention falls within the purview of the related art that is already known to those skilled in the art.

### Document of Related Art

(Patent Document 1) Korean Patent Application Publication No. 10-2012-0052176

### SUMMARY OF THE INVENTION

Accordingly, the present invention has been made keeping in mind the above problems occurring in the related art, and the present invention is intended to propose an apparatus for protecting a copyright of a 3D object model and method therefor that in order to protect the copyright on a voxel-based 3D object model, rotates at least one voxel structure included in at least one rotation voxel range that is preset based on at least one axis of X, Y, and Z axes of the 3D object model so as to distort the shape of the original 3D object model for obfuscation and enables only an authorized user to use the 3D object model through decryption, thereby effectively protecting the copyright of the 3D object model.

In order to achieve the above object, according to the first aspect of the present invention, there is provided an apparatus for protecting a copyright of a 3D object model, the apparatus including: a first module generating an original 3D object model by combining several voxels with each other in a 3D space of X, Y, and Z axes; a second module calculating respective voxel lengths of the axes of the original 3D object model generated by the first module and based on a voxel length of a longest axis among the calculated voxel lengths of the axes, the second module extending lengths of the remaining axes, thereby obtaining a 3D space area; a third module generating an obfuscation unique key for protecting the copyright of the original 3D object model generated by the first module; a fourth module generating at least one rotation axis position, rotation voxel range, and rotation frequency based on the obfuscation unique key generated by the third module; and a fifth module axially rotating at least one voxel structure included in each rotation voxel range at a preset rotation angle by each rotation frequency in a direction based on each rotation axis position generated by the fourth module so as to distort a shape of the original 3D object model generated by the first module, thereby performing obfuscation.

Here, based on each rotation axis position generated by the fourth module, the second module may extend the lengths of the remaining axes to be equal to the voxel length of the longest axis among the calculated voxel lengths of the axes, thereby obtaining the 3D space area.

Preferably, the obfuscation unique key generated by the third module may be a random key randomly generated or a fixed key generated according to a preset rule.

Preferably, each rotation axis position generated by the fourth module may be a voxel point corresponding to a center of each voxel structure included in each rotation voxel range based on at least one axis of the X, Y, and Z axes of the original 3D object model generated by the first module.

Preferably, each rotation axis position generated by the fourth module may be one voxel point of each voxel structure included in each rotation voxel range based on at least one axis of the X, Y, and Z axes of the original 3D object model generated by the first module.

Preferably, each rotation voxel range generated by the fourth module may be an area including voxels coupled to each other on each axis, from one voxel point located on at least one axis of the X, Y, and Z axes of the original 3D object model generated by the first module to a voxel point spaced apart therefrom by a preset distance in a direction of the axis.

Preferably, based on at least one voxel located on one axis of the X, Y, and Z axes of the original 3D object model generated by the first module, each voxel structure included in each rotation voxel range generated by the fourth module may include voxels coupled to each other on the remaining axes.

Preferably, each voxel structure included in each rotation voxel range generated by the fourth module may be separately defined for each voxel on one axis of the X, Y, and Z axes of the original 3D object model generated by the first module, and is a plurality of unit voxel structures including voxels coupled to each other on the remaining axes based on the separately defined voxel, and the fifth module may axially rotate each unit voxel structure included in each rotation voxel range at the preset rotation angle by each rotation frequency in a direction based on each rotation axis position generated by the fourth module so as to distort the shape of the original 3D object model generated by the first module, thereby performing obfuscation.

Preferably, the preset rotation angle may be in a range of 1 to 180 degree angles.

Preferably, when the preset rotation angle is a 90 degree angle, each rotation frequency may be one to four times.

Preferably, the apparatus may further include a sixth module decrypting the obfuscated 3D object model of the fifth module in a same manner as the original 3D object model generated by the first module by using the obfuscation unique key generated by the third module.

According to the second aspect of the present invention, there is provided a method of protecting a copyright of a 3D object model, the method including: (a) generating, by a first module, an original 3D object model by combining several voxels with each other in a 3D space of X, Y, and Z axes; (b) calculating, by a second module, respective voxel lengths of the axes of the original 3D object model generated at step (a) and next, based on a voxel length of a longest axis among the calculated voxel lengths of the axes, extending lengths of the remaining axes, thereby obtaining a 3D space area; (c) generating, by a third module, an obfuscation unique key for protecting the copyright of the original 3D object model generated at step (a); (d) generating, by a fourth module, at least one rotation axis position, rotation voxel range, and rotation frequency based on the obfuscation unique key generated at step (c); and (e) axially rotating, by a fifth module, at least one voxel structure included in each rotation voxel range at a preset rotation angle by each rotation frequency in a direction based on each rotation axis position generated at step (d) so as to distort a shape of the original 3D object model generated at step (a), thereby performing obfuscation.

Here, based on each rotation axis position generated at step (d), the lengths of the remaining axes may be extended by the second module to be equal to the voxel length of the longest axis among the calculated voxel lengths of the axes, thereby obtaining the 3D space area at step (b).

Preferably, the obfuscation unique key generated at step (c) may be a random key randomly generated or a fixed key generated according to a preset rule.

Preferably, each rotation axis position generated by step (d) may be a voxel point corresponding to a center of each voxel structure included in each rotation voxel range based on at least one axis of the X, Y, and Z axes of the original 3D object model generated at step (a).

Preferably, each rotation axis position generated at step (d) may be one voxel point of each voxel structure included in each rotation voxel range based on at least one axis of the X, Y, and Z axes of the original 3D object model generated at step (a).

Preferably, each rotation voxel range generated at step (d) may be an area including voxels coupled to each other on each axis, from one voxel point located on at least one axis of the X, Y, and Z axes of the original 3D object model generated at step (a) to a voxel point spaced apart therefrom by a preset distance in a direction of the axis.

Preferably, based on at least one voxel located on one axis of the X, Y, and Z axes of the original 3D object model generated at step (a), each voxel structure included in each rotation voxel range generated at step (d) may include voxels coupled to each other on the remaining axes.

Preferably, each voxel structure included in each rotation voxel range generated at step (d) may be separately defined for each voxel on one axis of the X, Y, and Z axes of the original 3D object model generated at step (a), and is a plurality of unit voxel structures including voxels coupled to each other on the remaining axes based on the separately defined voxel, and at step(e), the fifth module may axially rotate at least one unit voxel structure included in each rotation voxel range at the preset rotation angle by each rotation frequency in a direction based on each rotation axis position generated at step (d) so as to distort the shape of the original 3D object model generated at step (a), thereby performing obfuscation.

Preferably, at step (e), the preset rotation angle may be in a range of 1 to 180 degree angles.

Preferably, at step (d), when the preset rotation angle is a 90 degree angle, each rotation frequency may be one to four times.

Preferably, the method may further include, after step (e), decrypting, by a sixth module, the obfuscated 3D object model of step (e) in a same manner as the original 3D object model generated at step (a) by using the obfuscation unique key generated at step (c).

According to the third aspect of the present invention, there is provided a computer-readable recording medium having a program recorded thereon, the program enabling the method of protecting the copyright of a 3D object model to be executed by a computer.

The method of protecting the copyright of the 3D object model according to the present invention may be realized as a computer-readable code in the computer-readable recording medium. The computer-readable recording medium includes all kinds of recording devices in which data that is readable by a computer system is stored.

For example, examples of the computer-readable recording medium include a ROM, a RAM, a CD-ROM, a magnetic tape, a hard disk, a floppy disk, a portable storage device, a non-volatile memory (flash memory), an optical data storage device, etc.

According to the apparatus for protecting the copyright of a 3D object model and method therefor of the present invention as described above, in order to protect the copyright of a voxel-based 3D object model, at least one voxel structure included in at least one rotation voxel range that is preset based on at least one axis of the X, Y, and Z axes of the 3D object model is rotated so as to distort the shape of the original 3D object model for obfuscation, and only an authorized user can use the 3D object model through decryption, whereby the copyright of the 3D object model can be effectively protected.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a block diagram illustrating an apparatus for protecting a copyright of a 3D object model according to an embodiment of the present invention;

FIG. 2 is a flowchart illustrating a method of protecting a copyright of a 3D object model according to an embodiment of the present invention; and

FIG. 3A. FIG. 3B and FIG. 3C are schematic views illustrating an example of executing obfuscation of a 3D object model applied to an embodiment of the present invention.

### DETAILED DESCRIPTION OF THE INVENTION

The above-described objects, features, and advantages will be described in detail with reference to the accompanying drawings so that the technical spirit of the present invention can be easily embodied by those skilled in the art to which the present invention belongs. In the description of the present disclosure, the detailed descriptions of known related constitutions or functions thereof may be omitted if they make the gist of the present invention unclear.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. The terminology used herein is for the purpose of describing particular embodiments only and is not intended to be limiting of example embodiments of the invention. As used herein, the singular forms “a”, “an”, and “the” are intended to include the plural forms as well, unless the context clearly indicates otherwise.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the invention. Thus, the terms used herein should be defined based on the meaning of the terms together with the description throughout the specification.

It should also be understood that when a component “includes” an element, unless there is another opposite description thereto, the component does not exclude another element but may further include the other element. Also, the terms “part”, “module”, and the like mean a unit for processing at least one function or operation and may be implemented by a combination of hardware and/or software.

Hereinafter, the embodiment of the present invention will be described in detail with reference to the accompanying drawings. However, various changes to the following embodiments are possible and the scope of the present invention is not limited to the following embodiments. Embodiments of the present invention are presented to make complete disclosure of the present invention and help those who are ordinarily skilled in the art best understand the invention.

A combination of each block of the accompanying block diagram and each step of the accompanying flow diagram can be performed by computer program instructions (execution engine). As these computer program instructions may be embedded with the processor of a general purpose computer, a special purpose computer, or other programmable data processing equipment, the program instructions performed by the processor of the computers or other programmable data processing equipment, can create a means of performing the functions illustrated in each block of the block diagram or in each step of the flow diagram. These computer program instructions may also be stored in a computer-usable or computer-readable memory for supporting the computers or other programmable data processing equipments to implement the functions in a specific way. Thus, the instructions stored in the computer-usable or computer-readable memory can create a manufactured item containing therein the instruction means of performing the functions illustrated in each block of the block diagram or in each step of the flow diagram.

Also, as these computer program instructions can be embedded with the computers or other programmable data processing equipment, a series of operation steps are performed on the computers and other programmable data processing equipment to create a computer-executed process such that instructions for operating the computers or other programmable data processing equipment can provide steps for executing the functions illustrated in each block of the block diagram and each step of the flow diagram.

Also, each block or each step may be a part of module, segment, or code which contains one or more practical instructions for implementing the specific logical functions. It should be noted that, in some alternative embodiments, the functions as mentioned in blocks or steps can be implemented out of order. For example, a couple of blocks or steps illustrated one after another can actually be implemented either simultaneously or sometimes in reverse order depending on the corresponding function.

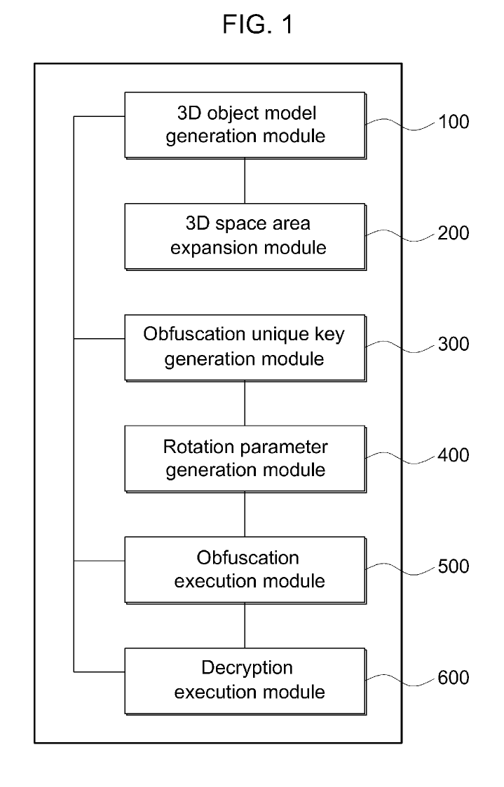

FIG. 1 is a block diagram illustrating an apparatus for protecting a copyright of a 3D object model according to an embodiment of the present invention.

Referring to FIG. 1, the apparatus for protecting a copyright of the 3D object model according to the embodiment of the present invention includes a 3D object model generation module (or a first module) 100, a 3D space area expansion module (or a second module) 200, an obfuscation unique key generation module (or a third module) 300, a rotation parameter generation module (or a fourth module) 400, an obfuscation execution module (or a fifth module) 500, etc.

Also, the apparatus for protecting the copyright of the 3D object model according to the embodiment of the present invention may further include a decryption execution module (or a sixth module) 600. In the meantime, the components shown in FIG. 1 are not essential, and thus the apparatus for protecting the copyright of the 3D object model according to the embodiment of the present invention may include more components or less components.

Hereinafter, component of the apparatus for protecting the copyright of a 3D object model according to the embodiment of the present invention will be described in detail as follows.

The 3D object model generation module 100 generates an original 3D object model by combining several voxels with each other in a 3D space of X, Y, and Z axes.

Here, it is desirable that the original 3D object model generated by the 3D object model generation module 100 is generated by, for example, a 3D printing device or 3D computer-aided design (CAD) rendering, etc., but it is not limited thereto. The 3D object model may be designed by a user by using a computer, a personal terminal (e.g., a smart phone, a smart pad, Smart Note, a palm PC, a mobile play-station, a digital multimedia broadcasting (DMB) phone with communication function, a tablet PC, an iPad, and other mobile terminals), etc.

The 3D space area expansion module 200 calculates voxel lengths of respective axes (the X, Y, and Z axes) of the original 3D object model generated by the 3D object model generation module 100, and based on the voxel length of the axis (e.g., the X axis) among the calculated voxel lengths of the axes (the X, Y, and Z axes), extends the lengths of the remaining axes (e.g., the Y and Z axes), thereby obtaining a 3D space area.

Here, it is desirable that based on the voxel length of the longest axis among the calculated voxel lengths of the axes, the 3D space area expansion module 200 extends the lengths of the remaining axes based on each rotation axis position generated by the rotation parameter generation module 400 to obtain the 3D space area.

For example, when each rotation axis position generated by the rotation parameter generation module 400 is a voxel point corresponding to the center of at least one voxel structure included in at least one rotation voxel range based on at least one axis of the X, Y, and Z axes of the original 3D object model generated by the 3D object model generation module 100, the 3D space area expansion module 200 extends the lengths of the remaining axes to be equal to the voxel length of the longest axis among the calculated voxel lengths of the axes so as to obtain the 3D space area.

The obfuscation unique key generation module 300 generates an obfuscation unique key for protecting the copyright of the original 3D object model generated by the 3D object model generation module 100.

Here, it is desirable that the obfuscation unique key generated by the obfuscation unique key generation module 300 is, for example, a random key randomly generated or a fixed key generated according to a preset rule.

The rotation parameter generation module 400 generates at least one rotation parameter such as a rotation axis position, a rotation voxel range, a rotation frequency, etc. based on the obfuscation unique key generated by the obfuscation unique key generation module 300.

Here, as an embodiment, based on at least one axis of the X, Y, and Z axes of the original 3D object model generated by the 3D object model generation module 100, at least one rotation axis position of rotation parameters generated by the rotation parameter generation module 400 may be a voxel point corresponding to the center of at least one voxel structure included in at least one rotation voxel range.

Also, as another embodiment, based on at least one axis of the

X, Y, and Z axes of the original 3D object model generated by the 3D object model generation module 100, at least one rotation axis position of the rotation parameters generated by the rotation parameter generation module 400 may be one voxel point of at least one voxel structure included in at least one rotation voxel range.

Also, as another embodiment, based on at least one axis of the X, Y, and Z axes of the original 3D object model generated by the 3D object model generation module 100, at least one rotation axis position of the rotation parameters generated by the rotation parameter generation module 400 may be one of voxel points differently located on at least one voxel structure included in at least one rotation voxel range.

Also, as another embodiment, based on one or more different axes of the X, Y, and Z axes of the original 3D object model generated by the 3D object model generation module 100, at least one rotation axis position of the rotation parameters generated by the rotation parameter generation module 400 may be one voxel point of at least one voxel structure included in at least one rotation voxel range.

Also, as another embodiment, based on at least one coaxial axis of the X, Y, and Z axes of the original 3D object model generated by the 3D object model generation module 100, at least one rotation axis position of the rotation parameters generated by the rotation parameter generation module 400 may be one of voxel points differently located on at least one voxel structure included in at least one rotation voxel range.

Also, as an embodiment, at least one rotation voxel range of the rotation parameters generated by the rotation parameter generation module 400 may be an area including all voxels coupled to each other on each axis, from one voxel point located on at least one axis of the X, Y, and Z axes of the original 3D object model generated by the 3D object model generation module 100 to a voxel point spaced apart therefrom by a preset distance in a direction of the axis.

Also, as an embodiment, based on at least one voxel located on one axis of the X, Y, and Z axes of the original 3D object model generated by the 3D object model generation module 100, at least one voxel structure included in at least one rotation voxel range of the rotation parameters generated by the rotation parameter generation module 400 may include all voxels coupled to each other on the remaining axes.

Also, as another embodiment, at least one voxel structure included in at least one rotation voxel range of the rotation parameters generated by the rotation parameter generation module 400 is separately defined for each voxel on one axis of the X, Y, and Z axes of the original 3D object model generated by the 3D object model generation module 100. Based on the separately defined voxel, at least one voxel structure may be a plurality of unit voxel structures including all voxels coupled to each other on the remaining axes.

In the meantime, when at least one rotation frequency of the rotation parameters generated by the rotation parameter generation module 400 is plural, it is desirable that each rotation frequency is generated in a form of a list (e.g., three times, two times, three times, two times, one time, . . . ).

Based on at least one rotation axis position generated by the rotation parameter generation module 400, the obfuscation execution module 500 axially rotates at least one voxel structure included in at least one rotation voxel range at a preset rotation angle by at least one rotation frequency in a direction to distort the shape of the original 3D object model generated by the 3D object model generation module 100, thereby performing obfuscation.

Here, it is desirable that the preset rotation angle is in, for example, a range of about 1 to 180 degree angles. When the preset rotation angle is a 90 degree angle, it is desirable that each rotation frequency is about one to four times.

Also, when at least one voxel structure included in at least one rotation voxel range generated by the rotation parameter generation module 400 is a plurality of unit voxel structures, based on each rotation axis position generated by the rotation parameter generation module 400, the obfuscation execution module 500 axially rotates each unit voxel structure included in each rotation voxel range at a preset rotation angle (preferably, a range of about 1 to 180 degree angles) by each rotation frequency in a direction to distort the shape of the original 3D object model generated by the 3D object model generation module 100, thereby performing obfuscation.

Also, based on each rotation axis position generated by the rotation parameter generation module 400, the obfuscation execution module 500 axially rotates each unit voxel structure included in each rotation voxel range at a preset rotation angle (preferably, a range of about 1 to 180 degree angles) by each different rotation frequency in a direction to distort the shape of the original 3D object model generated by the 3D object model generation module 100, thereby performing obfuscation.

Also, when the rotation frequency generated by the rotation parameter generation module 400 is in a form of a list, based on each rotation axis position generated by the rotation parameter generation module 400, the obfuscation execution module 500 axially rotates each voxel structure included in each rotation voxel range according to the generated list order at a preset rotation angle (preferably, a range of about 1 to 180 degree angles) by each rotation frequency in a direction to distort the shape of the original 3D object model generated by the 3D object model generation module 100, thereby performing obfuscation.

Also, based on each rotation axis position generated by the rotation parameter generation module 400, the obfuscation execution module 500 axially rotates each unit voxel structure included in each rotation voxel range according to the generated list order at a preset rotation angle (preferably, a range of about 1 to 180 degree angles) by each rotation frequency in a direction to distort the shape of the original 3D object model generated by the 3D object model generation module 100, thereby performing obfuscation.

By using the obfuscation unique key generated by the obfuscation unique key generation module 300, the decryption execution module 600 decrypts the obfuscated 3D object model of the obfuscation execution module 500 in the same manner as the original 3D object model generated by the 3D object model generation module 100.

Hereinafter, a method of protecting a copyright of a 3D object model according to an embodiment of the present invention will be described in detail.

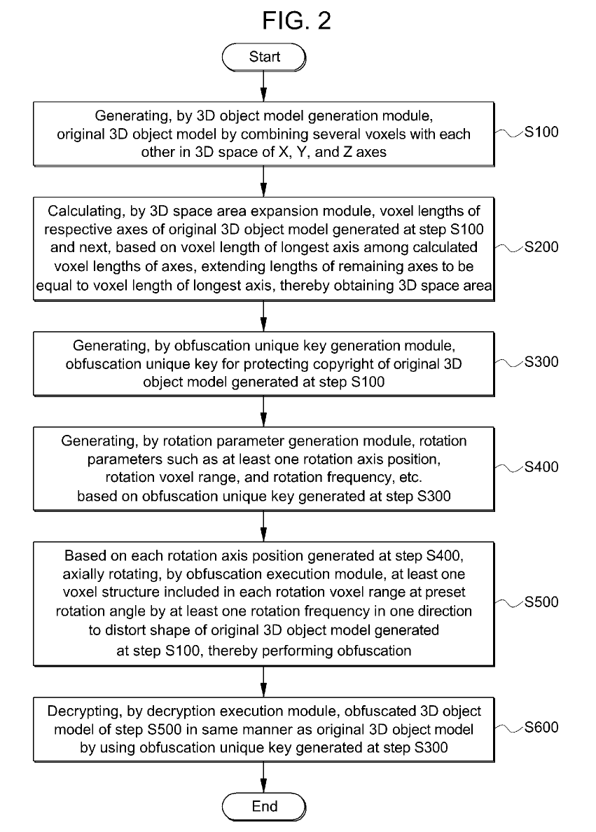

FIG. 2 is a flowchart illustrating a method of protecting a copyright of a 3D object model according to an embodiment of the present invention.

Referring to FIGS. 1 and 2, in the method of protecting the copyright of the 3D object model according to the embodiment of the present invention, first, the 3D object model generation module 100 generates an original 3D object model by combining several voxels with each other in a 3D space of the X, Y, and Z axes at step S100.

Here, it is desirable that the original 3D object model generated at step S100 is, for example, generated by a 3D printing device or 3D computer-aided design (CAD) rendering.

Next, after calculating, by the 3D space area expansion module 200, voxel lengths of respective axes of the original 3D object model generated at step S100, based on the voxel length of the longest axis among the calculated voxel lengths of the axes, a 3D space area is obtained by extending lengths of the remaining axes at step S200.

Here, at step S200, it is desirable that based on each rotation axis position generated at step S400, the 3D space area expansion module 200 extends the lengths of the remaining axes to be equal to the voxel length of the longest axis among the calculated voxel lengths of the axes so as to obtain a 3D space area.

Next, an obfuscation unique key for protecting the copyright of the original 3D object model generated at step S100 is generated by the obfuscation unique key generation module 300 at step S300.

Here, it is desirable that the obfuscation unique key generated at step S300 is, for example, a random key randomly generated or a fixed key generated according to a preset rule.

Next, based on the obfuscation unique key generated at step S300, rotation parameters such as at least one rotation axis position, rotation voxel range, and rotation frequency, etc. are generated by the rotation parameter generation module 400 at step S400.

Here, as an embodiment, based on at least one axis of the X, Y, and Z axes of the original 3D object model generated at step S100, at least one rotation axis position generated at step S400 may be a voxel point corresponding to the center of at least one voxel structure included in at least one rotation voxel range.

Also, as another embodiment, based on at least one axis of the X, Y, and Z axes of the original 3D object model generated at step S100, at least one rotation axis position generated at step S400 may be one voxel point of at least one voxel structure included in at least one rotation voxel range.

Also, as another embodiment, based on at least one axis of the X, Y, and Z axes of the original 3D object model generated at step S100, at least one rotation axis position generated at step S400 may be one of voxel points differently located on at least one voxel structure included in at least one rotation voxel range.

Also, as another embodiment, based on one or more different axes of the X, Y, and Z axes of the original 3D object model generated at step S100, at least one rotation axis position generated at step S400 may be one voxel point of at least one voxel structure included in at least one rotation voxel range.

Also, as another embodiment, based on at least one coaxial axis of the X, Y, and Z axes of the original 3D object model generated at step S100, at least one rotation axis position generated at step S400 may be one of voxel points differently located on at least one voxel structure included in at least one rotation voxel range.

Also, as an embodiment, at least one rotation voxel range generated at step S400 may be an area including all voxels coupled to each other on each axis, from one voxel point located on at least one axis of the X, Y, and Z axes of the original 3D object model generated at step S100 to a voxel point spaced apart therefrom by a preset distance in a direction of the axis.

Also, as an embodiment, based on at least one voxel located on one axis of the X, Y, and Z axes of the original 3D object model generated at step S100, at least one voxel structure included in at least one rotation voxel range generated at step S400 may include all voxels coupled to each other on the remaining axes.

Also, as another embodiment, at least one voxel structure included in at least one rotation voxel range generated at step S400 is separately defined for each voxel on one axis the X, Y, and Z axes of the original 3D object model generated at step S100. Based on the separately defined voxel, at least one voxel structure may be a plurality of unit voxel structures including all voxels coupled to each other on the remaining axes.

In the meantime, when at least one rotation frequency of the rotation parameters generated at step S400 is plural, it is desirable that each rotation frequency is generated in a form of a list (e.g., three times, two times, three times, two times, one time, . . . ).

Next, based on each rotation axis position generated at step S400, the obfuscation execution module 500 axially rotates at least one voxel structure included in each rotation voxel range at a preset rotation angle by at least one rotation frequency in a direction to distort the shape of the original 3D object model generated at step S100 so as to perform obfuscation at step S500.

Here, at step S500, it is desirable that the preset rotation angle is in a range of about 1 to 180 degree angles. When the preset rotation angle is a 90 degree angle, it is desirable that each rotation frequency is one to four times.

Also, at step S500, based on each rotation axis position generated at step S400, the obfuscation execution module 500 axially rotates at least one unit voxel structure included in each rotation voxel range at a preset rotation angle (preferably, a range of about 1 to 180 degree angles) by each rotation frequency in a direction to distort the shape of the original 3D object model generated at step S100 so as to perform obfuscation.

Also, at step S500, based on each rotation axis position generated at step S400, the obfuscation execution module 500 axially rotates each unit voxel structure included in each rotation voxel range at a preset rotation angle (preferably, a range of about 1 to 180 degree angles) by each different rotation frequency in a direction to distort the shape of the original 3D object model generated at step S100 so as to perform obfuscation.

Also, at step S500, based on each rotation axis position generated at step S400, the obfuscation execution module 500 axially rotates each voxel structure included in each rotation voxel range according to the generated list order at a preset rotation angle (preferably, a range of about 1 to 180 degree angles) by each rotation frequency in a direction to distort the shape of the original 3D object model generated at step S100 so as to perform obfuscation.

Also, at step S500, based on each rotation axis position generated at step S400, the obfuscation execution module 500 axially rotates each unit voxel structure included in each rotation voxel range according to the generated list order at a preset rotation angle (preferably, a range of about 1 to 180 degree angles) by each rotation frequency in a direction to distort the shape of the original 3D object model generated at step S100 so as to perform obfuscation.

Moreover, after step S500, by using the obfuscation unique key generated at step S300, the obfuscated 3D object model at step S500 is decrypted by the decryption execution module 600 at step S600 in the same manner as the original 3D object model generated at step S100.

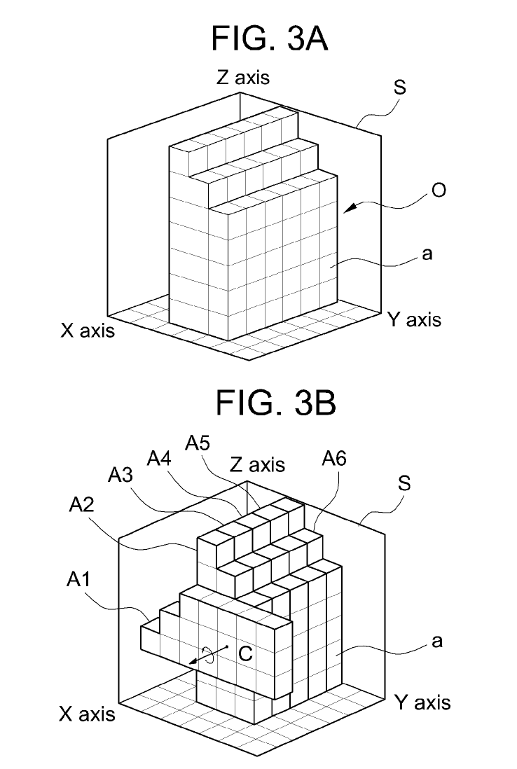

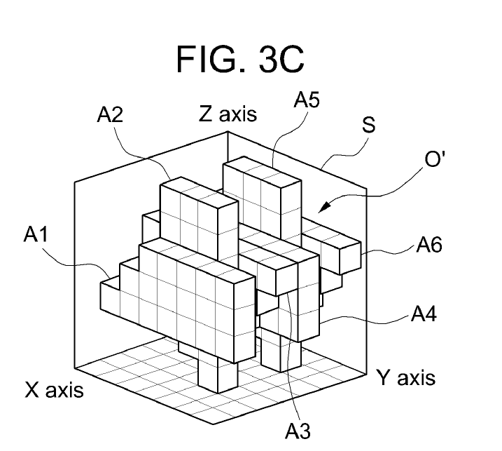

FIGS. 3A to 3C are schematic views illustrating an example of executing obfuscation of a 3D object model applied to an embodiment of the present invention.

Referring to FIGS. 3A to 3C, the 3D object model generation module 100 generates an original 3D object model (O) by combining several voxels (a) with each other in a 3D space of the X, Y, and Z axes. Next, based on the voxel length of the longest axis (e.g., the Z axis) among the voxel lengths of the axes of the original 3D object model (O), the 3D space area expansion module 200 extends the lengths of the remaining axes (e.g., the X and Y axes) to be equal to the voxel length of the longest axis so as to obtain a 3D space area (S).

Next, after generating an obfuscation unique key for protecting the copyright of the original 3D object model (O) by the obfuscation unique key generation module 300, the rotation parameter generation module 400 generates rotation parameters such as at least one rotation axis position, rotation voxel range, rotation frequency, etc. based on the generated obfuscation unique key.

Here, based on one axis (e.g., the X axis) of the X, Y, and Z axes of the original 3D object model (O), each rotation axis position of the rotation parameters generated by the rotation parameter generation module 400 is a voxel point corresponding to the center of the voxel structure included in the generated rotation voxel range.

Also, the voxel structure included in the generated rotation voxel range is separately defined for each voxel (a) on one axis (e.g., X axis) of the X, Y, and Z axes of the original 3D object model (O). Based on the separately defined voxel (a), the voxel structure is a plurality of unit voxel structures (e.g., A1, A2, A3, A4, A5, and A6) including all voxels coupled to each other on the remaining axes (e.g., the Y and Z axes).

With the rotation parameters, based on the rotation axis position, namely, a voxel point corresponding to the center (c) of each unit voxel structure (e.g., A1, A2, A3, A4, A5, and A6), the obfuscation execution module 500 axially rotates (e.g., rotation on the X axis) each unit voxel structure (e.g., A1, A2, A3, A4, A5, and A6) included in the generated rotation voxel range according to the generated list order (e.g., one time, two times, three times, one time, two time, and three times) at a preset rotation angle (e.g., a 90 degree angle) by each rotation frequency in a direction such that the shape of the original 3D object model (O) is distorted, whereby an obfuscated 3D object model (O′) is obtained.

In the meantime, the method of protecting the copyright of the 3D object model according to an embodiment of the present invention may be realized as a computer-readable code in the computer-readable recording medium. The computer-readable recording medium includes all kinds of recording devices in which data that is readable by a computer system is stored.

For example, examples of the computer-readable recording medium include a ROM, a RAM, a CD-ROM, a magnetic tape, a hard disk, a floppy disk, a portable storage device, a non-volatile memory (flash memory), an optical data storage device, etc.

Also, the computer-readable recording medium may be distributed among computer systems connected via a computer communication network, and may be stored and executed as a code that is readable by a decentralized manner.

Although a preferred embodiment of the apparatus for protecting the copyright of a 3D object model and method therefor according to the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for protecting a copyright of a 3D object model, the apparatus comprising:
a first module generating an original 3D object model by combining several voxels with each other in a 3D space of X, Y, and Z axes;
a second module calculating respective voxel lengths of the axes of the original 3D object model generated by the first module and based on a voxel length of a longest axis among the calculated voxel lengths of the axes, the second module extending lengths of the remaining axes, thereby obtaining a 3D space area;
a third module generating an obfuscation unique key for protecting the copyright of the original 3D object model generated by the first module;
a fourth module generating at least one rotation axis position, rotation voxel range, and rotation frequency based on the obfuscation unique key generated by the third module; and
a fifth module axially rotating at least one voxel structure included in each rotation voxel range at a preset rotation angle by each rotation frequency in a direction based on each rotation axis position generated by the fourth module so as to distort a shape of the original 3D object model generated by the first module, thereby performing obfuscation.

2. The apparatus of claim 1, wherein based on each rotation axis position generated by the fourth module, the second module extends the lengths of the remaining axes to be equal to the voxel length of the longest axis among the calculated voxel lengths of the axes, thereby obtaining the 3D space area.

3. The apparatus of claim 1, wherein the obfuscation unique key generated by the third module is a random key randomly generated or a fixed key generated according to a preset rule.

4. The apparatus of claim 1, wherein each rotation axis position generated by the fourth module is a voxel point corresponding to a center of each voxel structure included in each rotation voxel range based on at least one axis of the X, Y, and Z axes of the original 3D object model generated by the first module.

5. The apparatus of claim 1, wherein each rotation axis position generated by the fourth module is one voxel point of each voxel structure included in each rotation voxel range based on at least one axis of the X, Y, and Z axes of the original 3D object model generated by the first module.

6. The apparatus of claim 1, wherein each rotation voxel range generated by the fourth module is an area including voxels coupled to each other on each axis, from one voxel point located on at least one axis of the X, Y, and Z axes of the original 3D object model generated by the first module to a voxel point spaced apart therefrom by a preset distance in a direction of the axis.

7. The apparatus of claim 1, wherein based on at least one voxel located on one axis of the X, Y, and Z axes of the original 3D object model generated by the first module, each voxel structure included in each rotation voxel range generated by the fourth module includes voxels coupled to each other on the remaining axes.

8. The apparatus of claim 1, wherein each voxel structure included in each rotation voxel range generated by the fourth module is separately defined for each voxel on one axis of the X, Y, and Z axes of the original 3D object model generated by the first module, and is a plurality of unit voxel structures including voxels coupled to each other on the remaining axes based on the separately defined voxel, and
the fifth module axially rotates each unit voxel structure included in each rotation voxel range at the preset rotation angle by each rotation frequency in a direction based on each rotation axis position generated by the fourth module so as to distort the shape of the original 3D object model generated by the first module, thereby performing obfuscation.

9. The apparatus of claim 1, wherein the preset rotation angle is in a range of 1 to 180 degree angles.

10. The apparatus of claim 1, wherein when the preset rotation angle is a 90 degree angle, each rotation frequency is one to four times.

11. The apparatus of claim 1, further comprising:
a sixth module decrypting the obfuscated 3D object model of the fifth module in a same manner as the original 3D object model generated by the first module by using the obfuscation unique key generated by the third module.

12. A method of protecting a copyright of a 3D object model, the method comprising:
(a) generating, by a first module, an original 3D object model by combining several voxels with each other in a 3D space of X, Y, and Z axes;
(b) calculating, by a second module, respective voxel lengths of the axes of the original 3D object model generated at step (a) and next, based on a voxel length of a longest axis among the calculated voxel lengths of the axes, extending lengths of the remaining axes, thereby obtaining a 3D space area;
(c) generating, by a third module, an obfuscation unique key for protecting the copyright of the original 3D object model generated at step (a);
(d) generating, by a fourth module, at least one rotation axis position, rotation voxel range, and rotation frequency based on the obfuscation unique key generated at step (c); and
(e) axially rotating, by a fifth module, at least one voxel structure included in each rotation voxel range at a preset rotation angle by each rotation frequency in a direction based on each rotation axis position generated at step (d) so as to distort a shape of the original 3D object model generated at step (a), thereby performing obfuscation.

13. The method of claim 12, wherein based on each rotation axis position generated at step (d), the lengths of the remaining axes is extended by the second module to be equal to the voxel length of the longest axis among the calculated voxel lengths of the axes, thereby obtaining the 3D space area at step (b).

14. The method of claim 12, wherein the obfuscation unique key generated at step (c) is a random key randomly generated or a fixed key generated according to a preset rule.

15. The method of claim 12, wherein each rotation axis position generated by step (d) is a voxel point corresponding to a center of each voxel structure included in each rotation voxel range based on at least one axis of the X, Y, and Z axes of the original 3D object model generated at step (a).

16. The method of claim 12, wherein each rotation axis position generated at step (d) is one voxel point of each voxel structure included in each rotation voxel range based on at least one axis of the X, Y, and Z axes of the original 3D object model generated at step (a).

17. The method of claim 12, wherein each rotation voxel range generated at step (d) is an area including voxels coupled to each other on each axis, from one voxel point located on at least one axis of the X, Y, and Z axes of the original 3D object model generated at step (a) to a voxel point spaced apart therefrom by a preset distance in a direction of the axis.

18. The method of claim 12, wherein based on at least one voxel located on one axis of the X, Y, and Z axes of the original 3D object model generated at step (a), each voxel structure included in each rotation voxel range generated at step (d) includes voxels coupled to each other on the remaining axes.

19. The method of claim 12, wherein each voxel structure included in each rotation voxel range generated at step (d) is separately defined for each voxel on one axis of the X, Y, and Z axes of the original 3D object model generated at step (a), and is a plurality of unit voxel structures including voxels coupled to each other on the remaining axes based on the separately defined voxel, and
at step (e), the fifth module axially rotates at least one unit voxel structure included in each rotation voxel range at the preset rotation angle by each rotation frequency in a direction based on each rotation axis position generated at step (d) so as to distort the shape of the original 3D object model generated at step (a), thereby performing obfuscation.

20. The method of claim 12, wherein at step (e), the preset rotation angle is in a range of 1 to 180 degree angles.

21. The method of claim 12, wherein at step (d), when the preset rotation angle is a 90 degree angle, each rotation frequency is one to four times.

22. The method of claim 12, after step (e), further comprising:
decrypting, by a sixth module, the obfuscated 3D object model of step (e) in a same manner as the original 3D object model generated at step (a) by using the obfuscation unique key generated at step (c).

23. A computer-readable recording medium having a program recorded thereon, the program enabling any one method of claims 12 to be executed by a computer.
